(19) United States
(12) Patent Application Publication
(10) Pub. No.: US 2009/0072495 A1
(43) Pub. Date: Mar. 19, 2009

(54) Sealing system, in particular for attachment connections on flow paths for hot gases

(76) Inventors: Wilhelm Kullen, Hulben (DE); Martin Kehr, Bad Urach (DE); Kurt Schwenkel, Hulben (DE); Eberhard Griesinger, Munsingen (DE); Albert Lennerth, Eningen (DE); Peter Braun, Ehingen (DE); Reiner Wolf, Hayingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/898,934

(22) Filed: Sep. 17, 2007

(30) Foreign Application Priority Data
Sep. 17, 2007 (DE) 10 2006 045 585.1

(51) Int. Cl. F16J 15/12; F01N 7/16; F02F 11/00

(52) U.S. Cl. 277/630

(57) ABSTRACT

A sealing system, in particular for attachment connections on flow paths for hot gases, such as exhaust gas flows from internal combustion engines, with a sealing support (3) and at least one sealing element (1) that defines a sealing plane that is located between sealing surfaces, characterized in that the sealing support (3), as a separate component, is separated from the sealing element (1) as another separate component, and in that the two components are captively connected to one another to preserve the sealing system.

The invention relates to a sealing system, in particular for attachment connections on flow paths for hot gases, such as exhaust gas flows from internal combustion engines, with a sealing support and at least one sealing element that defines a sealing plane that is located between sealing surfaces.

In the case of attachment connections to be sealed in hot gas areas, as in combustion engines, for example, in the manifold exhaust, in the turbocharger, in the catalytic converter or else in the connection area between the cylinder head and exhaust gas manifold, both high thermal stresses and mechanical stresses occur, so that for the associated sealing systems, high design cost is required. As sealing elements, metal seals that are made of heat-resistant material alloys are used, whereby the exhaust-gas-carrying connecting parts in their function as sealing supports must have a groove or a shelf for a pertinent, ring-shaped sealing element. This design means not only a considerable production expense, but rather also results in a mechanical weakening of the relevant connecting parts.

Problems also arise with respect to assembly safety, since in the assembly processes, it must be taken into account that at the respective attachment connection, the pertinent sealing elements are actually present and are not inadvertently omitted, and that they are correctly positioned at the connecting parts.

With respect to these problems, the object of the invention is to make available a sealing system that is distinguished by a design that makes possible cost-effective production, whereby, moreover, assembly safety is ensured.

According to the invention, this object is achieved by a sealing system that has the features of claim 1 in its entirety.

In that, as specified in the characterizing part of claim 1, the sealing support is a separate component, which separates from the sealing element as another separate component, but in addition is captively connected to the sealing element, on the one hand the assembly process is especially simple and secure, since there is no chance that the sealing support will be installed without an existing sealing element. On the other hand, compared to the prior art, significantly reduced production costs result, since, on the one hand, no processing expense on the connecting parts, for example by design of grooves or shelves for the sealing element, is necessary, and since, on the other hand, only the functionally relevant sealing elements themselves have to be produced from expensive, heat-resistant materials, while the sealing support can be produced from a less expensive material.

For this purpose, the arrangement is preferably designed so that the sealing support, when it is secured in the installed state between connecting parts of the attachment connection, secures the sealing element at least to oppose a movement that runs in a direction that is transverse to the sealing plane or releases it for a sealing process. Depending on the thermal stresses and/or the geometry of the sealing element, a rigid connection between a sealing support and a sealing element may be more advantageous, for example by the sealing element with the sealing support being press-fitted, welded, cemented or clamped into the sealing support, or it may be more advantageous to configure the connection so that in the installed state in a corresponding deformation, which is produced in the sealing element during the sealing process under the effect of the sealing force, a specific movement of the sealing element is possible relative to the sealing support.

Preferably, as a sealing support, a ring element that has a seat on at least one edge section for the sealing element and that forms the captive connection of sealing element and sealing support is provided.

Instead of a ring element, which is installed as a sealing support between the respective connecting parts of the attachment connection, a flat, plate-like or flange-like component with at least one through-opening can be provided, on the opening edge of the respective through-opening that surrounds the flow path, at least one edge section for the sealing element having a seat that forms the captive connection of sealing element and sealing support. Such an embodiment of the sealing support in the type of a plate is suitable in particular for attachment connections between an exhaust gas manifold and a cylinder head of an internal combustion engine. For this purpose, the sealing support can be extended by several exhaust-gas outlets that are adjacent to one another on the cylinder head, the sealing support on the edge sections of several through-openings working together with sealing elements, so that for several sealing elements on attachment connections that are adjacent to one another, a single sealing support is provided.

In advantageous embodiments, a sealing element that forms a mold is provided, the seat on the respective edge section of the sealing support having at least one surface part that extends along a peripheral section of the mold.

For this purpose, the arrangement can be designed such that the seat to secure the mold has at least two surface parts to oppose movements running in both directions transverse to the sealing plane, and said surface parts lap over a peripheral section of the mold, interposing itself between said surface parts, on both sides of the sealing plane.

To form such surface parts that lap over the mold at least in certain sections, the seat for the mold can be formed by an annular groove that is recessed in the radial direction on the edge section of the sealing support and in which the mold engages with at least one peripheral section. The mold can be clamped into the annular groove in such a way that a limited relative movement between mold and sealing support is possible.

The mold with the sealing support, however, can also be press-fitted, by the support parts of the seat, extending along a peripheral section of the ring element, being formed for the sealing element by plastic deformation of the respective edge section of the sealing support in certain sections.

In the case of especially advantageous embodiments, a mold with a C-, U- or V-shaped profile cross-section or with a meandering cross-sectional shape or a mold that is formed by a combined crimping ring is provided as a sealing element.

Preferably, such a mold is provided relative to the sealing support and in the flow path in such a positional arrangement that the profile shape of the mold is opened radially inward. In such positional orientation, not only is the design of the connection between mold and sealing support on the seat of the same especially simple, but rather especially good ratios, with respect to the sealing action, are produced based on the profile shape that is open toward the flow path, since in operation, the mold is put under pressure by the profile interior; this has the effect of widening the mold and increasing its sealing force.

In an especially advantageous embodiment, an inner ring that surrounds the flow path is inserted, in particular fixed, inside the profile as fire protection, which produces a reduction in temperature in the sealing area, this being of great importance in the case of very high exhaust gas temperatures.

Below, the invention will be explained in detail based on the embodiments depicted in the drawing.

Here:

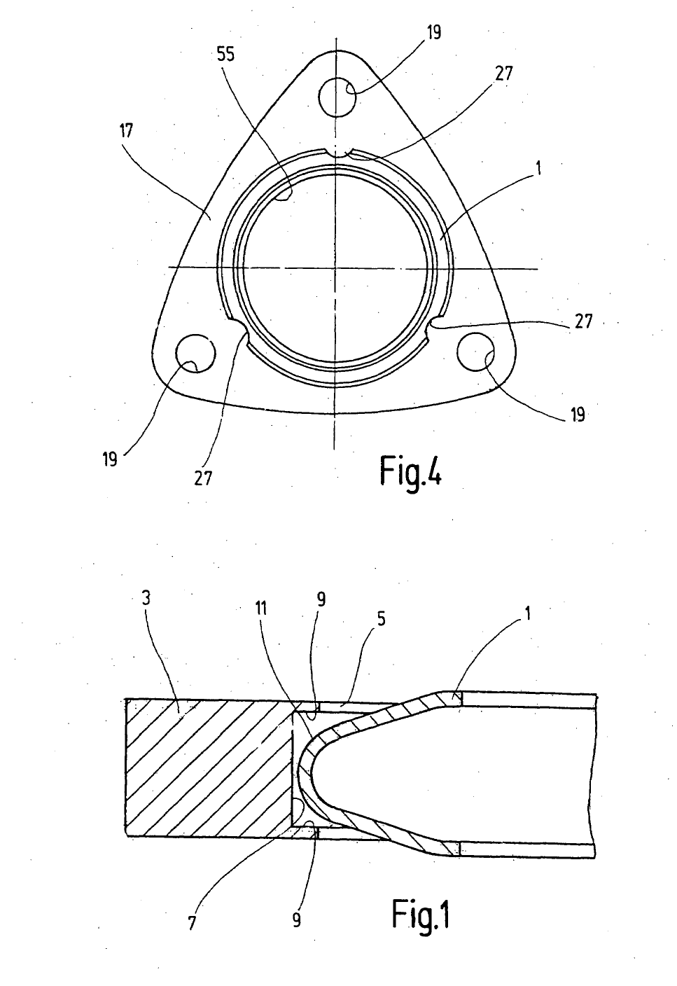

FIG. 1 shows a partial longitudinal section drawn in cutaway of a first embodiment of the sealing system according to the invention, only an end-section of the embodiment, located on the left side, being shown on a greatly enlarged scale compared to a real embodiment;

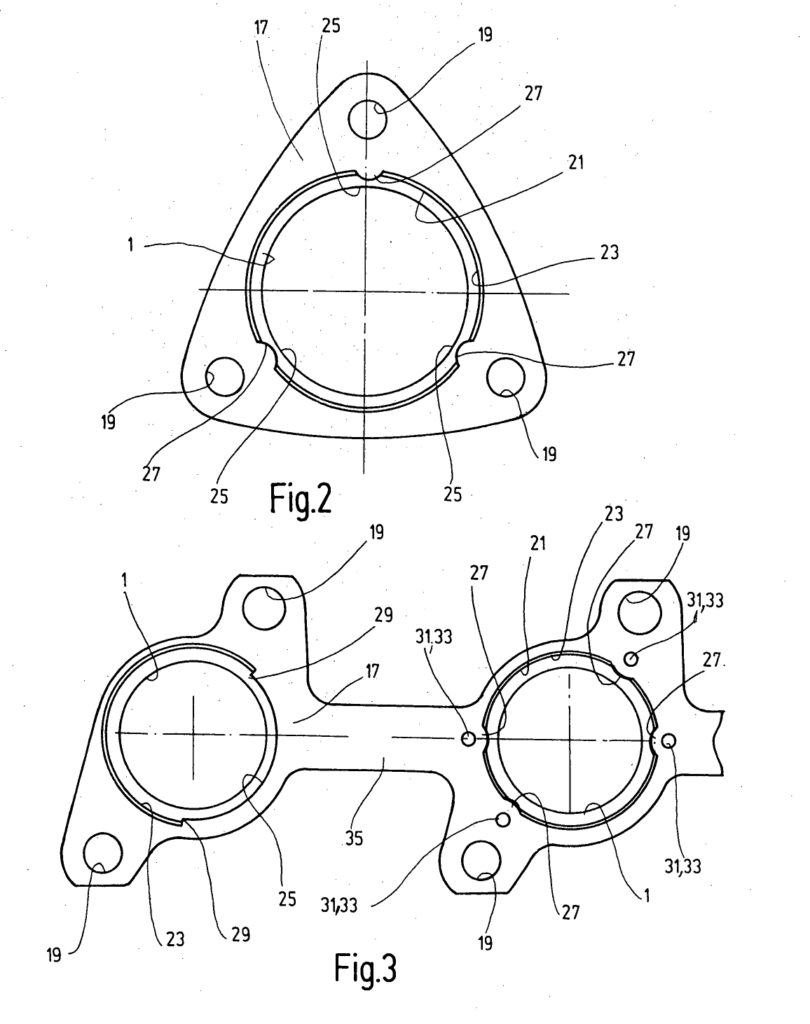

FIG. 2 shows a top view, shown in approximately full scale, of a further embodiment of the sealing system with a flange-like sealing support;

FIG. 3 shows a top view, shown relative to FIG. 2 on an approximately comparable scale, of a plate-like sealing support drawn in cutaway, in the figure on the left side and the right side, two different embodiments of the sealing system being shown;

FIG. 4 shows a top view, similar to FIG. 2, of another embodiment of the sealing system;

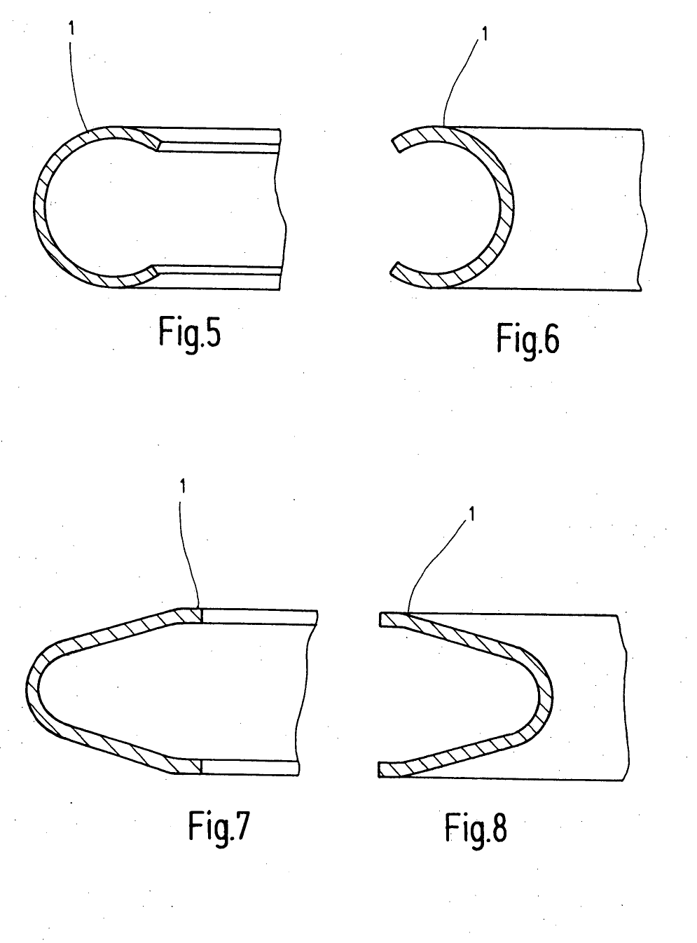

FIGS. 5 to 11 show a longitudinal section drawn in cutaway, greatly enlarged relative to a practical embodiment, of only one outside end area of different designs of molds for use as a sealing element in the sealing system according to the invention;

FIG. 12 shows a partial longitudinal section drawn in cutaway, also shown on a greatly enlarged scale, of another embodiment of the sealing system, only the connecting area between sealing support and mold being shown; and

FIGS. 13 to 20 show partial longitudinal sections similar to FIG. 12 of other embodiments of the sealing system, FIG. 20 showing a partial section relative to the subject of FIG. 4.

The axial plots, configured vertically and shown in FIG. 1 as well as FIGS. 5 to 20, relate to the longitudinal axes of the respective flow paths that are to be sealed.

FIG. 1 shows a first embodiment of the sealing system, in the partial longitudinal section drawn in cutaway, shown on an exaggeratedly large scale, only the connecting area between a sealing support and a sealing element in the form of a metallic mold 1 being shown, in which there is a one-piece profile element, whose profile has a V-shaped cross-sectional shape. The mold 1 is associated with a sealing support, which has the shape of a circular, metallic ring element 3, which can be secured between connecting parts, not shown, of a respective attachment connection so that it forms a flow path for a hot gas, for example an exhaust gas flow, together with the mold 1. On its annular edge 5 lying radially inward, the ring element 3 has a seat for the mold 1, in the example of FIG. 1, an annular groove 7 that is recessed in radial direction being provided as a seat. The mold 1, whose profile shape is open inward in the flow path, is clamped into the annular groove 7, so that the inner walls 9 of the annular groove 7 that run parallel to the sealing plane lap over the peripheral section 11 of the mold 1, which interposes itself between said surface parts, and therefore form a captive fastening for the mold 1.

FIGS. 5 to 11 illustrate different designs of molds 1, as they can advantageously be used in the embodiment of FIG. 1 as well as in the further embodiments of the sealing system according to the invention that are to be described below. Thus, FIGS. 7 and 8 show a one-piece mold with a V-shaped profile cross-sectional shape, the profile in FIG. 7, just like in the example of FIG. 1, being open radially inward, while FIG. 8 shows a mold 1 with a V-shaped profile shape, which, however, is closed radially inward. FIGS. 5 and 6 in each case show a mold 1 with a C-shaped profile shape, which is open radially inward in FIG. 5 and radially outward in FIG. 6.

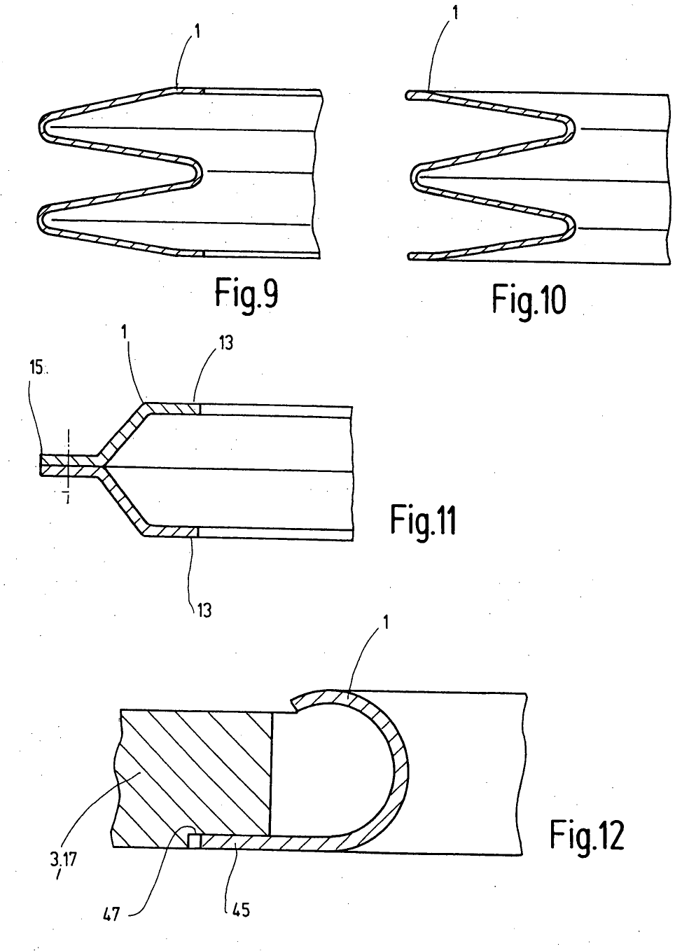

FIGS. 9 and 10 also show one-piece molds 1 with a meandering profile cross-sectional shape, which is open radially inward in FIG. 9 and radially outward in FIG. 10. The meandering cross-sectional shape of the mold 1 of FIGS. 9 and 10 is distinguished by greater “spring travel” of the mold 1 in the deformation by the acting sealing force, compared to the profile shapes according to FIGS. 5 to 8.

FIG. 11 shows a mold 1, built up by combining two metal crimping rings 13. The crimping rings 13 can be combined for forming the mold 1, in such a way that they are tightly connected to one another on a flat end edge 15 that lies radially outward, for example by welding or cementing, or that they are held together in the respective seat of the associated sealing support, as is the case in the embodiment of FIG. 19 that is to be described below.

FIG. 2 shows a modified embodiment, in which the sealing support, unlike in the example of FIG. 1, is not a circular ring element 3, but rather a flat, flange-like component 17, which has the shape of a trirondular configuration, in the three corner areas, in each case a hole 19 being present, which allows the threaded bolts to pass through if the component 17 is mounted in the installed state between the respective connecting parts, not shown. The component 17 has a through-opening 23, on whose inside edge 21 surrounding the flow path is provided in turn a seat for a sealing element, in which it is in turn a mold, as is to be seen in particular in FIGS. 5 to 11. In the embodiment of FIG. 2, this seat is located in each case on an edge section 25 of the opening 23, which is opposite to one of the holes 19. In each of these edge sections 25, the inside edge 21 is press-fitted, specifically from both sides of the component 17, so that plastic surface parts 27 that are deformed radially inward lap over the mold 1 on both sides. Further details of such a design of the seat by press-fitting are also explained in more detail based on the description of FIGS. 16 and 17.

FIG. 3 shows a further embodiment of the sealing system, in which the sealing support, much like in FIG. 2, is a flat component 17, which is configured, however, like a plate and has several through-openings 23, configured in a series, for several exhaust-gas outlets of a cylinder head. As in the flange-like component 17 of FIG. 2, holes 19 for threaded bolts are provided in the plate-like component 17. In FIG. 3, in the through-opening 23 for the mold 1, which is shown on the left side, a seat is provided that extends on the edge section 25 between end positions 29 and, as shown more clearly in FIG. 13 and is likewise the case in the example of FIG. 1, it is formed by an annular groove 7, whose side walls 9 lap over a peripheral section 11 of the mold 1 on both sides.

In the through-opening 23 that is located on the right side, FIG. 3 shows a design of the seat for the mold 1, which is similar to the embodiment of FIG. 2. As is shown more clearly in FIGS. 16 and 17, holes 31, see FIG. 16, or notches 33, see FIG. 17, are present on the inside edge 21 of the opening 23, starting from which the component 17 is press-fitted, so that plastic surface parts 27, deformed radially inward, lap over a peripheral section 11 of the mold 1, see FIGS. 16 and 17.

With the use of a plate-like component 17, as is shown in FIG. 3, in the case of attachment connections on a cylinder head, measures can be provided on a plate-like component 17 to produce a thermal decoupling between the connecting parts and the cylinder head. For this purpose, the plate ridge 35 between the openings 23 is made narrow to reduce the heat-conducting surface. In addition, further measures can be provided, for example breakthroughs in the component 17, to reduce the support surface, or anti-friction measures can also be provided on the plate-like or flange-like components 17.

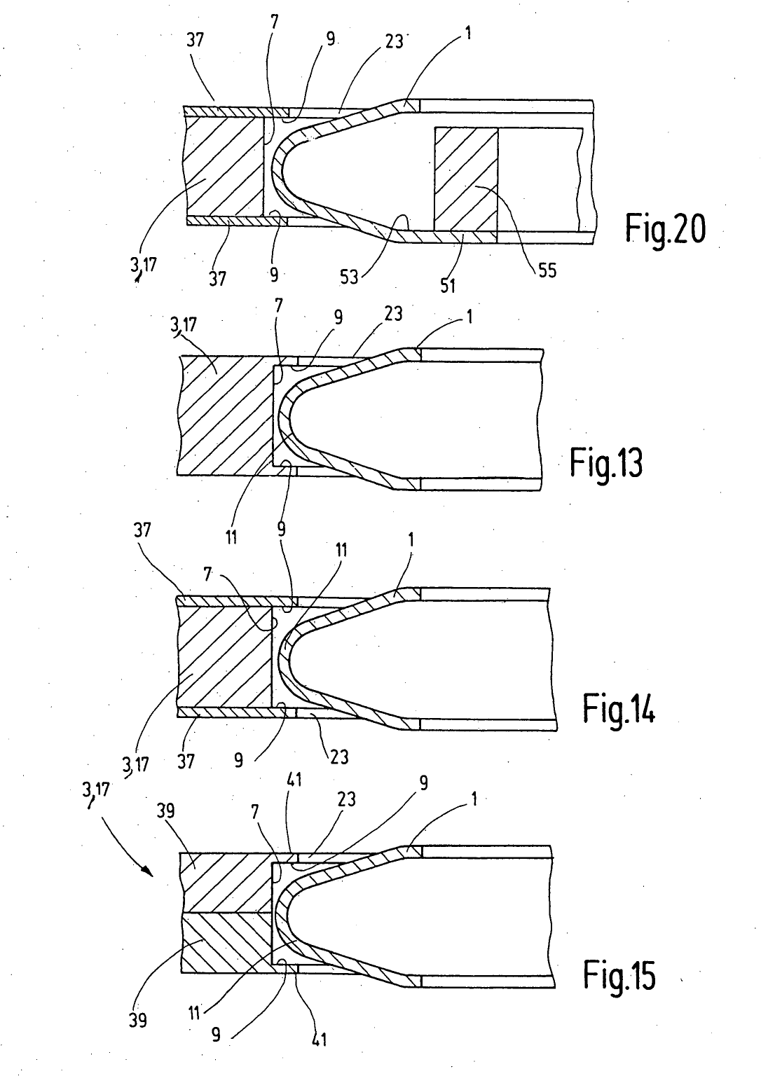

FIGS. 14 and 15 show alternative possibilities of the design of an annular groove 7 as a seat for the mold 1. In the example of FIG. 14, the side walls 9 of the annular groove 7, which lap over the peripheral section 11 of the mold, are formed by flat, disk-shaped components 37, which project radially inward to the through-opening 23 via the component 17 and form the walls 9 of the annular groove 7 with the projecting parts.

FIG. 15 shows a further alternative to the design of the annular groove 7 such that the sealing support 3 or 17 consists of two identical mirror-image plates 39 (by cementing, welding, etc.), each plate 39, on its end that is axially removed from the sealing plane, having an edge 41, projecting radially inward, to form the side wall 9 of the annular groove 7.

In the foregoing, embodiments were described in which the mold 1 is oriented in each case on the sealing support, so that the profile is open radially inward. FIG. 12 illustrates an example in which the mold 1 is oriented with a C-profile on the sealing support, which can be a ring element 3 or flat component 17, such that the profile is open radially outward. In this example, a profile leg 45 that extends radially outward and forms an extension of the profile is present on one end of the C-form, and said profile leg rests on a support surface 47 that is stepped backward axially and extends parallel to the sealing plane (welded, cemented or otherwise attached).

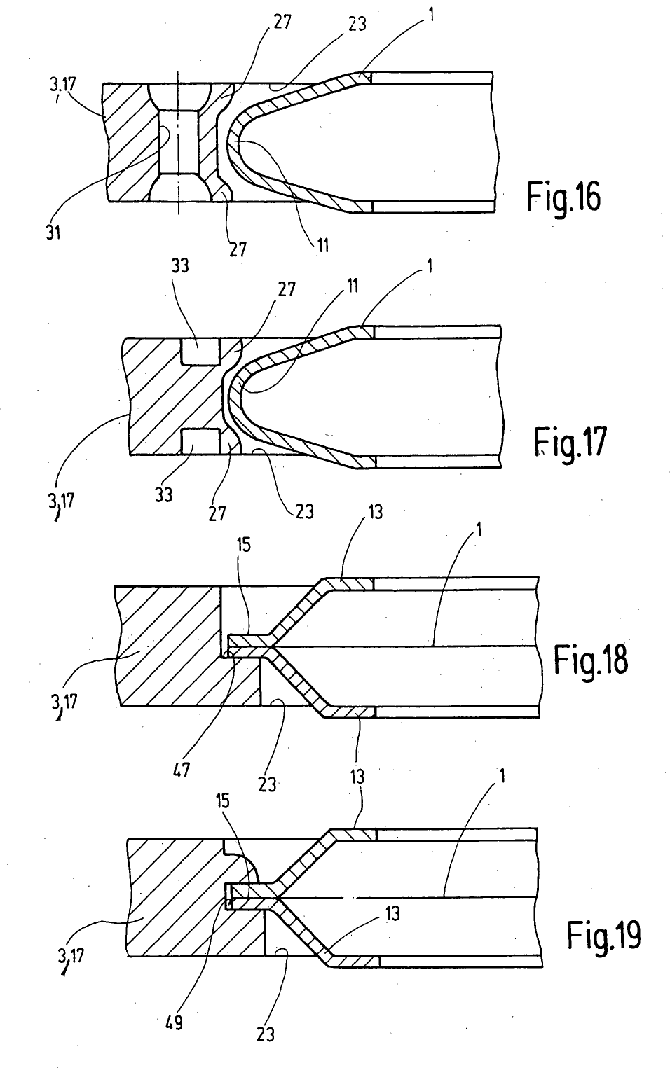

As already mentioned, a mold 1, which is combined from crimping rings 13, is shown in FIG. 11. FIG. 18 shows an example of the arrangement of such a mold 1 on the sealing support, i.e., a ring element 3 or a flat component 17, the end edge 15 of the mold 1 in turn being held on a support surface 47, which extends parallel to the sealing plane as a gradation at the sealing support 3, 17 as in the example of FIG. 12, it being possible for the end edge 15 in turn to be connected to the support surface 47 in a suitable way.

FIG. 19 shows that the mold 1, combined from crimping rings 13, is clamped with its end edge 15 in a suitable groove 49 on the opening 23 of the sealing support 3, 17. In this connection, if there is a suitable fit, the fastening of the two crimping rings 13 one below another may be unnecessary.

FIGS. 4 and 20 illustrate an especially advantageous embodiment of the sealing system. Here, in turn, a mold 1 with a V-shaped profile cross-section is used, the profile being open radially inward. Analogously as in the example of FIG. 12, the profile has a profile leg 51 that extends the profile shape and in this case projects radially inward and forms a support surface 53 that runs parallel to the sealing plane on the inside. A metal ring 55 that is used as fire protection is inserted resting on the latter, and said ring surrounds the flow path and forms a thermal barrier as a protective shield for the mold 1 in the case of very high exhaust gas temperatures. In the example of FIG. 20, the seat on the sealing support 3, 17 is formed in turn by an annular groove 7, whose configuration corresponds to the example of FIG. 14.

FIG. 4 shows the application of the principle of the fire protection, shown in FIG. 20, by means of an inserted ring 55 in the example of a sealing support in the form of a flat, flange-like component 17, as it is also used in the example of FIG. 2. As in this embodiment, the securing of the mold 1 is effected by press-fitting, i.e., by surface parts 27, which are formed by plastic deformation of the flange-like component 17 in certain sections. It is understood that even when using a ring 55 that is used in fire protection instead of the press-fitting shown in FIG. 4, one of the other possible designs of the seat on the sealing support 3, 17 can be provided. Also, an inner ring 55 in a mold 1 of another profile shape can be inserted, for example, in a C-shape or U-shape or in a meandering shape, etc., if a corresponding profile leg is provided as seating for the ring 55. To the extent that reference is made to a ring element as the sealing element, this includes approximately circular embodiments in addition to spherical embodiments. Additionally, the term “sealing ring or mold” also extends to ring embodiments with oval shape or those with a rectangular design, preferably the corners of the rectangle having a rounded design. Other ring forms are possible here. The respective images of the mold or sealing ring preferably follow the respective geometry thereof.

1. Sealing system, in particular for attachment connections on flow paths for hot gases, such as exhaust gas flows from internal combustion engines, with a sealing support (3; 17) and at least one sealing element (1) that defines a sealing plane that is located between sealing surfaces, characterized in that the sealing support (3; 17), as a separate component, is separated from the sealing element as another separate component, and in that the two components are captively connected to one another to preserve the sealing system.

2. The sealing system according to claim 1, wherein the sealing support (3; 17), secured in the installed state between connecting parts of the attachment connection, secures the sealing element (1) at least to oppose a movement that runs in a direction transverse to the sealing plane or releases it for a sealing process.

3. The sealing system according to claim 2, wherein as a sealing support, a ring element (3) that has a seat (7) on at least one edge section (5) for the sealing element (1) and that forms the captive connection of sealing element (1) and sealing support (3), is provided.

4. The sealing system according to claim 2, wherein as a sealing support, a flat, plate-like or flange-like component (17) with at least one through-opening (23) is provided, on whose opening edge (21) surrounding the flow path at least one edge section (25) for the sealing element (1) has a seat, which forms the captive connection of sealing element (1) and sealing support.

5. The sealing system according to claim 3 or 4, wherein a sealing element that forms a mold (1) is provided, and the seat on the respective edge section (25) of the sealing support (3; 17) has at least one surface part (9; 27; 47) that extends along a peripheral section (11) of the mold (1).

6. The sealing system according to claim 5, wherein the seat for securing the mold (1) has at least two surface parts (9; 27) to oppose movements running in both directions transverse to the sealing plane, and said surface parts lap over a peripheral section (11) of the mold (1), interposing itself between said surface parts, on both sides of the sealing plane.

7. The sealing system according to one of claims 3 to 6, wherein the seat is formed by an annular groove (7), recessed in the radial direction on the edge section (5; 25) of the sealing support (3: 17), in which the mold (1) engages with at least one peripheral section (11).

8. The sealing system according to claim 7, wherein the walls (9) of the annular groove (7) that run parallel to the sealing plane are formed by disk-shaped components (37), lying on both sides on the sealing support (3; 17), with an opening surrounding the flow path and whose opening edge forms the respective side wall (9) of the annular groove (7).

9. The sealing system according to one of claims 6 to 8, wherein the surface parts (27) of the seat that extend along a section (25) of the sealing support (17) are formed for the mold (1) by plastic deformation, in certain sections, of the respective edge section (25) of the sealing support (17).

10. The sealing system according to one of claims 5 to 9, wherein as a sealing element, a mold (1) with a C-, U- or V-shaped profile cross-section or with a meandering cross-sectional shape or a mold (1) that is formed by combined crimping rings (13) is provided.

11. The sealing system according to one of claims 5 to 10, wherein a mold (1) with a profile shape that is open radially inward is provided.

12. The sealing system according to claim 11, wherein inside the profile, an inner ring (55) that surrounds the flow path is inserted as fire protection.
